(19) United States
(12) Patent Application Publication
(10) Pub. No.: US 2023/0141315 A1
(43) Pub. Date: May 11, 2023

(54) GRAYSON RANGE EXTENDER (GRE) 3.0: ADVANCED KINETIC ENERGY RECOVERY SYSTEM: High Speed, High Efficiency, Heat Resistant, Fluid Turbine Generator Type Range Extender, Motor and Recharger for Electric Vehicles, Equipment, Devices and Machinery

(71) Applicant: Michael Curtis Grayson, Richmond Hill, NY (US)

(72) Inventor: Michael Curtis Grayson, Richmond Hill, NY (US)

(21) Appl. No.: 17/868,939

(22) Filed: Jul. 20, 2022

Related U.S. Application Data
(63) Continuation-in-part of application No. 17/590,779, filed on Feb. 1, 2022.
(60) Provisional application No. 63/259,492, filed on Jul. 20, 2021.

(51) Int. Cl. B60L 53/52; H02K 7/18; B60L 53/60

(52) U.S. Cl. CPC B60L 53/52; B60L 53/60; H02K 7/1823; B60L 2200/10; B60L 2200/32

(57) ABSTRACT

A high-speed, high efficiency, heat resistant, fluid turbine generator type range extender, motor and recharger apparatus for electric vehicles, appliances, equipment, devices and machinery. The apparatus includes a computer controlled, adjustable Concentrating Ducting Inlet (CDI) which controls the flow of a subject fluid, high speed heat and warp resistant turbine comprised of circular heat and warp resistant discs, outer fluid cooled casing to hold the discs, an axle that is connected to the discs, armature windings, permanent magnets, a pancake shaped stator and rotor, a charge controller, a computer control system, and sensors. Additionally provided is a Smart Electronic Shim (SES), Smart Storage Device (SSD) which is a combination of an ultracapacitor and battery storage device with a battery management system, charge strip, viscous coupler, gearing, storage devices and battery bank, a charge controller controls a high-speed turbine connected to a high efficiency generator and the battery bank.

### PRIORITY

This application is a continuation-in-part of co-pending U.S. Pat. Application No. 17/590,779 filed with the U.S. Pat. and Trademark Office on Feb. 1, 2022, the entire contents of which is incorporated herein by reference. This application also claims benefit of U.S. Provisional Pat. Applications No. 63/259,492 filed with the U.S. Pat. and Trademark Office on Jul. 20, 2021, the entire contents of which is incorporated herein by reference.

### BACKGROUND OF THE INVENTION

### Field of the Invention

The present invention relates generally to the field of car electronics and electrical systems and, in particular, to a high-speed high efficiency heat resistant fluid turbine generator type range extender, motor, and recharger for electric vehicles, and particularly for dramatically increasing a vehicle’s driving range and greatly reducing or eliminating the need for recharging.

### Description of the Related Art

Although pure electric automobiles have the advantage of energy-savings, environmental protection, and zero discharge, the continual mileage range is currently very limited. In order to achieve mass application and acceptance the electric vehicle range must meet or exceed that of conventional fossil fuel powered vehicles. Currently 400 miles is the average range for a fossil fuel vehicle. This range has become standard and is very consumer friendly because of the fact that there is a wide choice of gas stations available and refueling takes only five minutes. It would be very easy to give gas cars a higher range, just put in a bigger tank. For electric vehicles, the solution is not as simple. The average range of an electric vehicle is currently 150 miles. Adding more battery as the solution for perceived range needs only adds more cost to the profitability-challenged electrified vehicle. Vehicle costs already too high for mainstream customers and given the inherent cost disadvantages faced by EV’s vs. conventional vehicles and less financial policy support in the future, even the current $50 per additional mile of cost to the vehicle is quite impractical, given the number/frequency of trips that truly require most of the battery range. Larger batteries will also incur larger warranty expenses for the OEM as well as greater freight & recycling costs.

More Mass on the Vehicle. Batteries are very heavy. Compensating with Lightweight Materials is Expensive. In order to meet very stringent fuel economy & CO₂ targets globally (primarily China. Europe, US & CA), all vehicles will have to be lighter and more mass efficient. Automotive OEM’s will pay more in premium materials for weight savings. Adding 4 lbs. of battery mass is roughly equal to 1 mile of EV range.

Longer Charging Times to Top-off. Charging Infrastructure for Long Distance Trips under currently under Development however no solution is close at hand.

Key Customers today are very accustomed to short re-fueling times at gas stations. Charging an EV is a much different experience and has been a challenge since the days of Edison’s efforts to supply the first batteries for electric cars. The larger the batteries become, the more and faster charging solutions that are required and continuous high-power charging can increase battery degradation.

Less Packaging Space for other Components. More stuff on vehicles expected with high tech features and autonomous driving leaves less room for batteries and not more. As batteries become larger to provide more range, given a fixed vehicle size, packaging of components and new features become an acute challenge for all of the elements requiring space within the vehicle architecture including passenger and cargo carrying expectations. Future self-driving systems will further accentuate this issue as well as require more energy consumption.

More Structural Requirements for Crashworthiness. Must protect the bigger batteries. We are often reminded that both gas tanks and batteries contain so much energy and they need to be carefully protected from thermal events that can occur during crashes. Larger batteries are greater engineering challenges requiring more substantive structures/systems.

More Robust Support Systems Required Mass Begets Mass. As the battery grows and the mass of the vehicle increases, other components from brakes, suspension, thermal management. etc. must be designed and reinforced to handle these challenges; the result is even more mass and cost added to the vehicle.

Without solutions to all these problems the electric vehicle just cannot advance.

### SUMMARY

A device referred to as the Grayson Range Extender (GRE) 3.0 Advanced Kinetic Energy Recovery System is provided.

The GRE device addresses each of these problems in a practical, reliable and cost-effective way. The device includes a wheel based permanent magnet generator that has the advantage of high efficiency, high power density, and has more wide application prospect.

In existing technology, the GRE will prove to be a compatible device that can quickly integrate with all current electrical vehicle platforms. The present invention proposes the conversion of the wheel assembly into a permanent magnet generator.

In order to gain exponential range extension, the present invention provides more power for greater horsepower, and creates a platform that will have immediate and long-term environmental benefits while simultaneously reducing charging times, improving EV overall efficiency, the present invention adopts following technical scheme:

A kind of electric vehicle recharging system that greatly extends the range of any vehicle, said kind of high-speed high efficiency heat resistant fluid turbine generator type range extender and recharger for electric vehicles, Grayson Range Extender (GRE) 3.0. is characterized in that it comprises: a computer controlled Concentrating Ducting Inlet (CDI) which controls the flow of a subject fluid, a high-speed heat resistant turbine comprised of circular heat and warp resistant discs, a fluid cooled outer casing to hold the disc, an armature winding, permanent magnets, a charge controller; flat pancake generators; a battery bank; an axle that is connected to the disc, a computer control system; sensors, a smart electronic shim, an ultracapacitor storage device, a charge strip, a viscous coupler, gearing, micro and mini grids and other componentry.

The present invention provides a modular scalable frictionless system that can be attached at numerous places on the subject vehicle the power produced is scalable to the desired recharge time and range.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of some embodiments and do not limit the disclosure.

FIG. 1 is the sectional view of the placement of a Concentrating Ducting Inlet (CDI) on a sample vehicle;

FIG. 2 is the sectional view of the function of the CDI in an embodiment;

FIG. 3 shows a cross-section view of the casing;

FIG. 4 shows an internal cross-sectional view of the casing;

FIG. 5 shows an exhaust port and intake nozzle of the outer casing;

FIG. 6 shows an exploded view of a pancake shaped generator according to an embodiment;

FIG. 7 shows an embodiment of a stack generator;

FIG. 8 shows an embodiment of a charge controller;

FIG. 9 shows an embodiment of a smart shim electronic spacer;

FIG. 10 shows an embodiment of a viscous coupler;

FIG. 11 shows an embodiment of a gear multiplier;

FIG. 12 shows an embodiment of an electronic fleet management system;

FIG. 13 shows an embodiment of a smart storage system (ultracapacitor, battery, battery management system, inverter/rectifier);

FIG. 14 shows an embodiment of a recharging/discharging/V2X cable;

FIG. 15 shows an embodiment of a GRE microgrid unit including recharger/discharger-inverter rectifier battery pack- battery management unit;

FIG. 16 shows an embodiment of a supergreen energy tanker;

FIG. 17 shows an embodiment of a Special Weaponized Autonomous Reconnaissance Machines (S.W.A.R.M.); and

FIG. 18 shows an embodiment of a mobile bitcoin mining rig;

### DETAILED DESCRIPTION

Embodiments of the invention provide a system, apparatus and methods for extending the range of electric vehicles.

Disclosed is a kind of high-speed high efficiency heat resistant fluid turbine generator type range extender, motor, and recharger apparatus for electric vehicles, dramatically increasing the electric vehicle driving/operational range and greatly reducing or eliminating the need for recharging, effectively lowering the sprung weight of the vehicle and speeding recharge times.

This high-speed high efficiency heat resistant warp resistant turbine, high-capacity generator, computer control system, charge controller and other components are all completely concealed by the body of the vehicle. The magnetic field is created through electric current in the wire-wound coil. The armature coil assembly converts the mechanical energy of the rotating axel into electrical energy by passing the permanent magnet through the armature winding. The Rotor produces rotating magnetic flux or rotating magnetic field associated with the rotor inducing electricity in the armature coil attached to the high-speed turbine. The electricity produced is then diverted to the charge controller. The charge controller now powers the engine directly, stores the energy, or recharges the battery based on the current needs of the vehicle.

This device takes advantage of the viscous effect of fluids on a solid surface. When fluid enters the CDI, the fluid enters the outer casing tangential to the casing. The outer casing holds the discs. Upon the fluid entering the inlet to the outer casing the interaction between the fluid and the disc will cause the disc to spin. The spinning discs are connected to a shaft which spin the rotor in the generator and create electricity. Provision for the fluid to leave the casing is at the center of the turbine. Inlet fluid with higher pressure than the atmosphere is entering the inlet nozzle and exit the hole at atmospheric pressure. The greater the disc speed the more the fluid particles move away from the center as a result of centrifugal forces forming a spiral pattern of travel which increase the contact area of the fluid thereby increasing the viscous force on the disc, which in turn increases the RPM of the shaft, which produces more electricity. The faster the turbine rotates the more energy it extracts from the fluid which creates greater RPMs at the shaft.

The casing contains multiple circular disc that are kept apart approximately 0.4 mm apart in Device 1, but the distance will vary based on configuration and design. The distance of the disc can be controlled by the smart electronic shim device that van vary the space or distance between plates electronically. These thin discs are constructed of anti-warp heat resistant materials. The disc takes advantage of the boundary layer effect. The device is constructed so that the turbine and fluid work in the same plane. The Casing device takes advantage of the low-pressure exhaust which draws the fluid to the discharge port and smoothly guides the fluid to the exhaust port. The discharge ports are placed at the lateral part of the casing toward the center. At the center of the device is an axle. The axle is connected to the rotor. This adjustable turbine is a simple axle with several thin disc arranged at an optimal distance to reduce drag forces. Placed inside the casing right at the center of the vortex. The discs are designed to draw the fluid to the exhaust port. The Disc have incorporated electronic spacers which create paths to guide the air to the center exhaust hub. The discs are arranged in a stepping staircase design which helps to create a vortex in the device. This device uses Front and rear cover with exhaust ports, and Turbine disc with holes in the center for exhaust.

The computer-controlled CDI is designed so that it gradually constricts the passage of fluid which increase the speed and pressure of the fluid. This process is optimized by the computer to maximize the viscous force on the disc. The CDI will use a Convergent divergent style nozzle to accelerate the fluid. The CDI also incorporates a computer-controlled Flow regulator.

Benefits of the high-speed high efficiency heat resistant fluid turbine generator type range extender, motor, and recharger apparatus for electric vehicles include, but are not limited to: (1) system increases the range of an electric vehicle up to 400%; (2) compared with traditional range extenders this device requires no additional fuels; (3) compared with traditional generators this device has much greater charging capacity and reliability; (4) compared with other types of recharging systems like regenerative breaking and diesel-powered range extenders, this system has lower coefficient of friction, generates an exponentially higher amounts of electricity and is infinitely more reliable: (5) can be very applicable and installed on all existing Electric Vehicles; (6) compared to other range extenders this device lowers the sprung weight of the vehicle; and (7) compared to other range extenders this device has zero emissions.

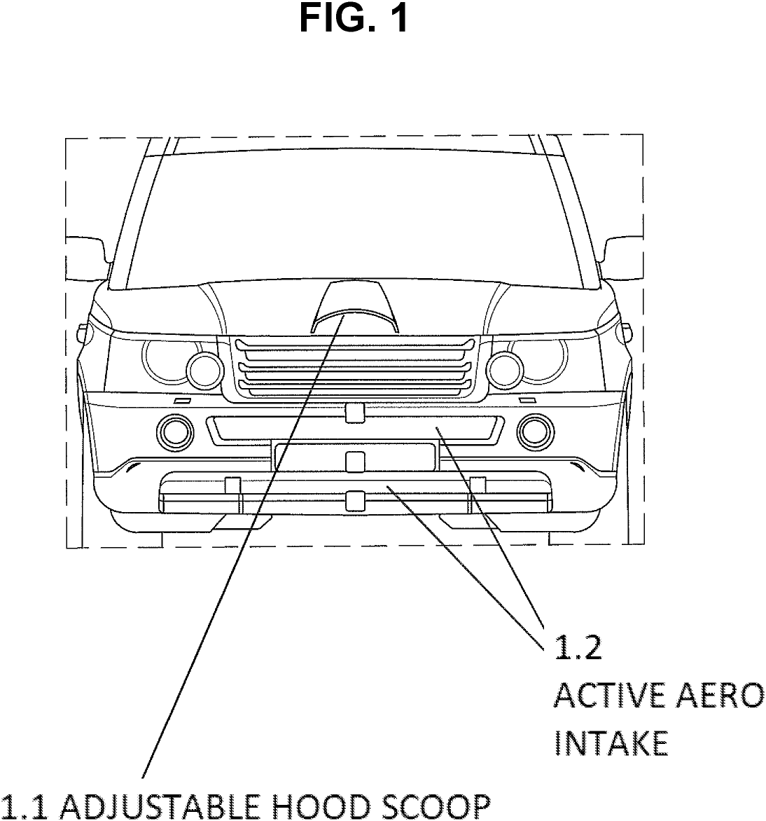

FIG. 1 is a sectional view of the placement of the Concentrating Ducting Inlet (CDI) on an sample vehicle. In the case of a first device (e.g.. Device 1) the CDI can be attached to the vehicle in numerous places to maximize the fluid flow capture. This device is computer controlled to maximize the introduction of fluid into the CDI and the viscous force on the disc. As the fluid inters the CDI it is directed to the casing inlet. The shape of the CDI is such that it encourages maximum fluid entry while promoting aerodynamics. In addition, the CDI has a flexible opening to allow for maximum fluid entry and to reduce fluid entry whenever necessary.

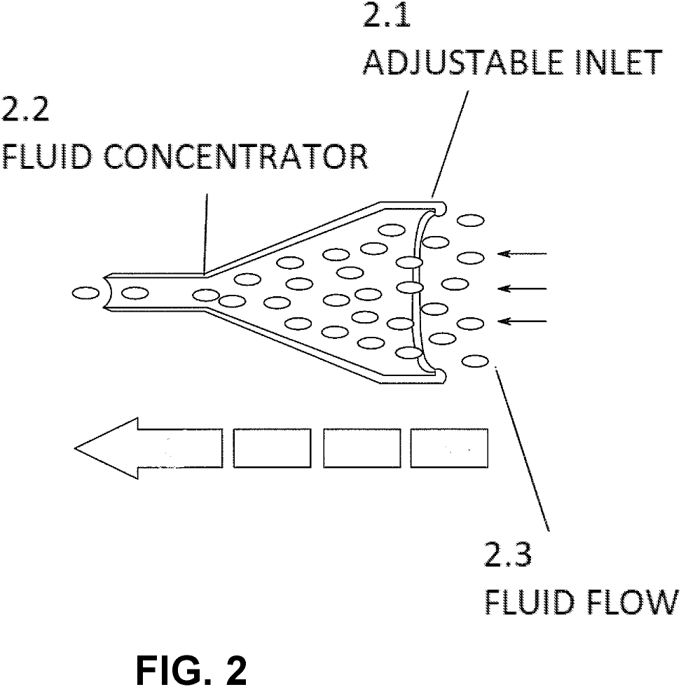

FIG. 2 is the sectional view illustrating the function of the CDI. In the case of Device 1, the fluid enters the front of the device and is forced through an hourglass shaped opening that concentrates the force of the moving fluid and increases the speed and pressure of the fluid through the ducting inlet.

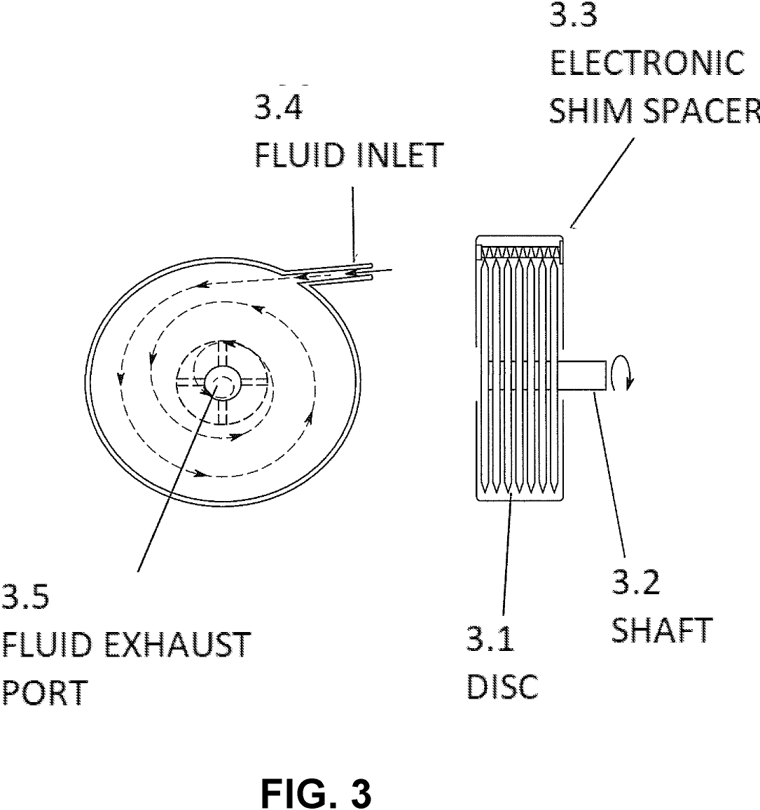

FIG. 3 shows a cross-section view of the casing. Here, the fluid cooled outer casing is designed to hold the thin heat resistant disc. Fluid circulates around the casing and help cool the device. The casing adds protection for the disc and helps to maintain the proper gaping using the electronic computer-controlled shim spacer. This device allows an added degree of control over the amount of charge generated. The casing is designed to force the fluid into a circular flow inside the casing which forces the disc to spin. The casing is comprised of several heat resistant disc that are spaced such that they maximize flow, increase spin, and minimize resistance. The casing houses the axel which is mounted in the center of the device and is connected to the disc. As the disc spin the axle spins and thereby turn the rotor which is housed in the generator. The casing has an exhaust port and an inlet for the fluid flow.

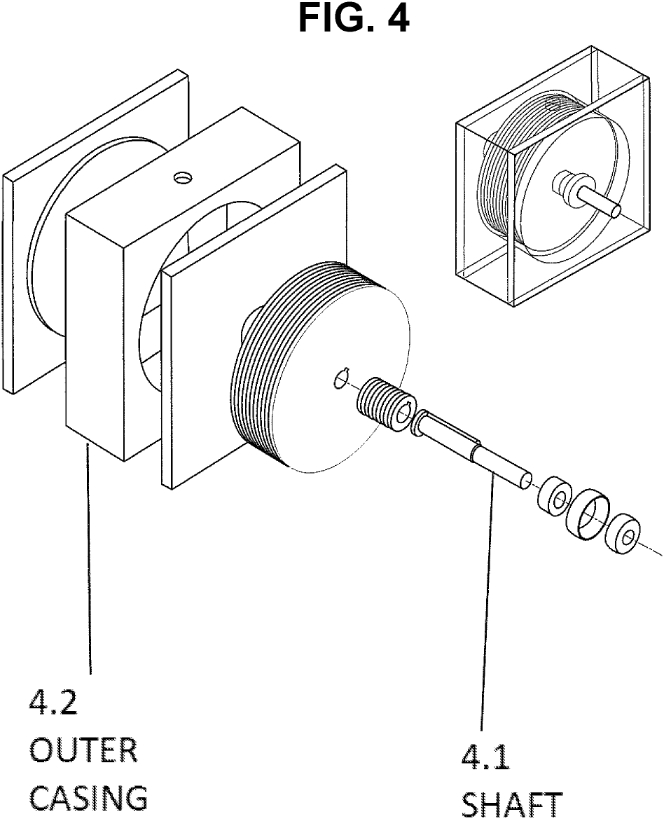

FIG. 4 shows an internal cross-sectional view of the casing. The discs have exhaust ports. The disc space is controlled electronically. The discs are spaced apart to reduce drag, maximize flow, and increase spin. The discs are attached to an axel. The force of the fluid on the disc force them to spin and thereby turn the axel.

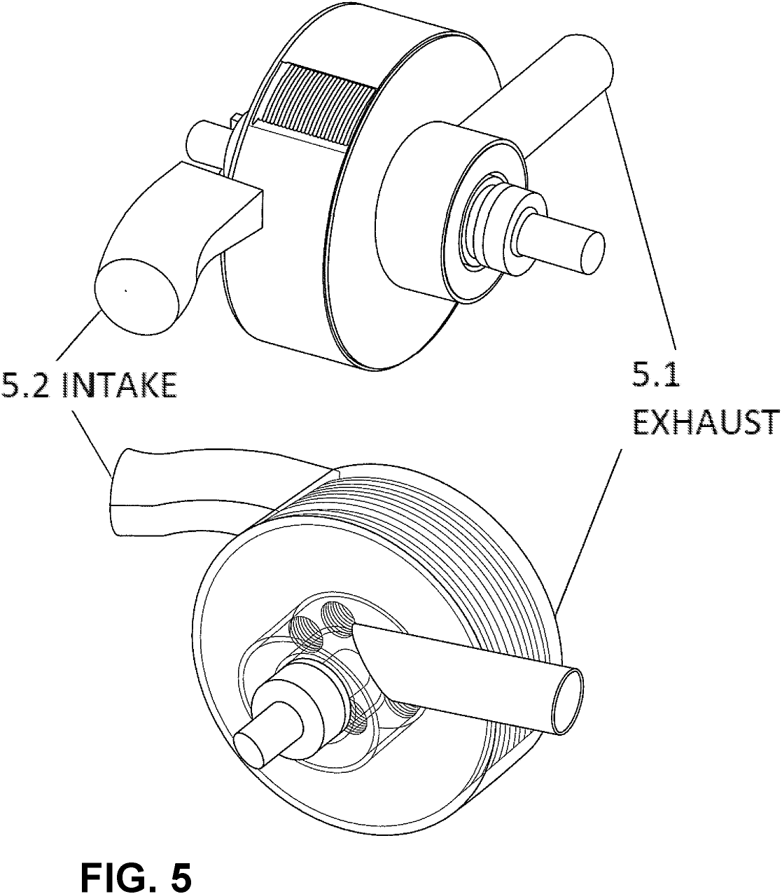

FIG. 5 depicts an exhaust port and intake nozzle of the outer casing. FIG. 5 more particularly shows a sample placement of the casing device and its exhaust port and inlet. The spinning of the disc forces the axle to rotate.

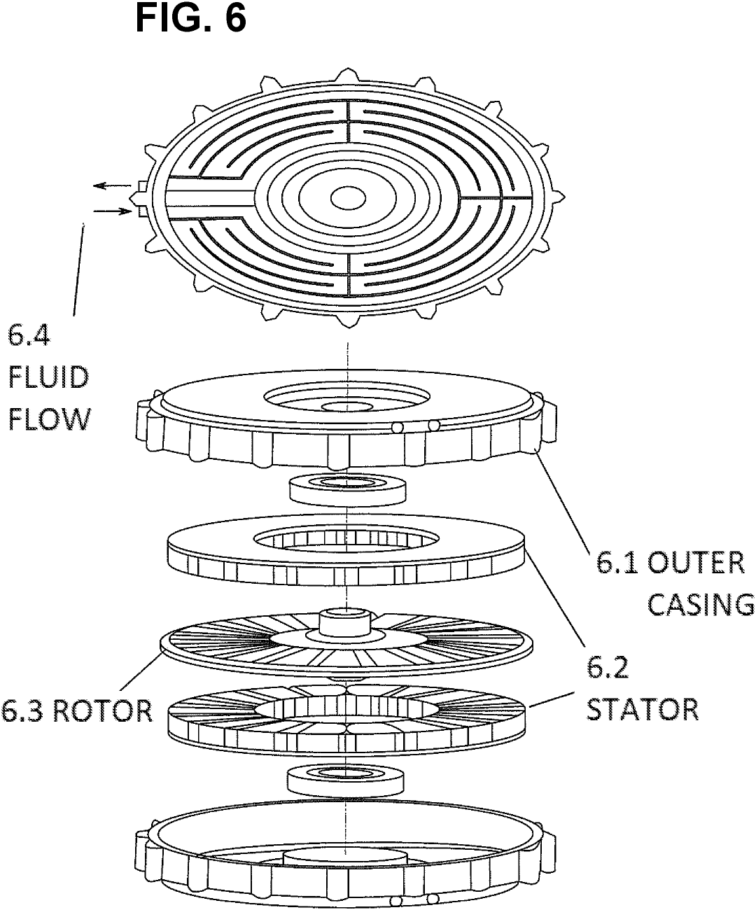

FIG. 6 depicts an exploded view of a pancake shaped generator. The axel from the casing spins the rotor in the generator, thus becomes the rotor. The Rotor produces rotating magnetic flux or rotating magnetic field associated with the rotor inducing electricity in the stator. The of at least two stators are made of a wired arm that are arranged at intervals around a center wheel hub pancake. Each armature is attached in sequence to the flat pancake disk. The rotor is arranged in a pattern of five or more magnets and adhered on the disk. The rotor is comprised of permanent magnets which are incorporated in the pancake disk. The stator assembly converts the mechanical energy of the rotating rotor disc into electrical energy by passing the armature coils through the permanent magnet assembly. The magnetic rotor cluster is placed on the disc in alternating the north and south pole of each magnet. Showing the magnetic lines inducing current. Electrical conductors moving through a steady magnetic field, or stationary conductors within a changing magnetic field, will have circular currents induced within them by induction, called eddy currents. Eddy currents flow in closed loops in planes perpendicular to the magnetic field. This constitutes the generator assembly which is cooled by ducts in the motor housing. Airflow from the device is directed through the ducts to cool the device itself. The generator is housed in a casing.

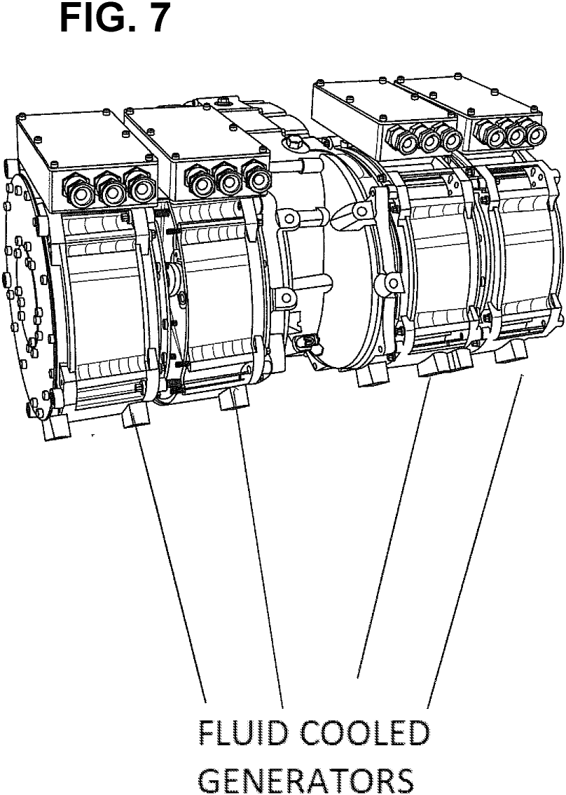

FIG. 7 depicts a stack generator according to an embodiment. This device is modular and scalable. The pancake generators can be stacked together in series along a single axel. Together they comprise the stack generator. There is no limit to the number or size of this device. The electricity created by the stack generator is feed to the charge computer. Identity

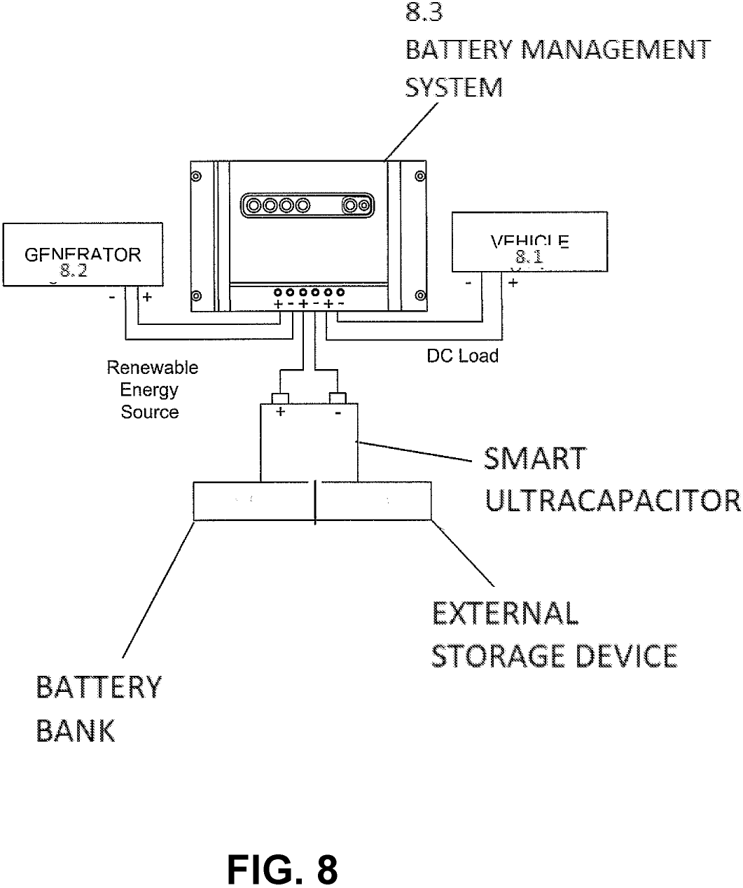

FIG. 8 depicts a charge controller. In an embodiment, the electricity produced from the generator is diverted to the charge controller. The charge controller now powers the engine directly, sends the charge to a storage device or recharges the battery based on the needs of the pre-programmed needs vehicle. The charge controller, charge regulator or battery regulator directs the electricity to the ultracapacitor which is designed for high volume and fast charging. The charge leaves the ultracapacitor and flows through the charge controller again to manage the rate at which electric current is added to or drawn from the battery bank. It prevents overcharging and protects against overvoltage, which can reduce battery performance or lifespan and may pose a safety risk. It also prevents completely draining (“deep discharging”) of the battery pack, or perform controlled discharges, depending on the battery technology, to protect battery life. The terms “charge controller” or “charge regulator” may refer to either a stand-alone device, or to control circuitry integrated within a battery pack, battery-powered device, or battery charger. The charge controller is also a power regulator. The charge controller has additional features, such as a low voltage disconnect (LVD), a separate circuit which powers down the load when the batteries become overly discharged (some battery chemistries are such that over-discharge can ruin the battery). The series charge controller or series regulator disables further current flow into batteries when they are full. The shunt function diverts excess electricity to an auxiliary or “shunt” load when batteries are full. The charge controllers stop charging a battery when they exceed a set high voltage level and re-enable charging when battery voltage drops back below that level. This device offers Pulse width modulation (PWM) and maximum power point tracker (MPPT) technologies. adjusting charging rates depending on the battery’s level, to allow charging closer to its maximum capacity. The charge controller with this MPPT capability frees the system from closely matching available PV voltage to battery voltage. Considerable efficiency gains can be achieved, particularly when the PV array is located at some distance from the battery. Higher array voltage means lower array current, so the savings in wiring costs can more than pay for the controller. The Charge controller also monitors battery temperature to prevent overheating. The charge controller systems also display data, transmit data to remote displays, and data logging to track electric flow over time. Circuitry that functions as a charge regulator controller may consist of several electrical components, or may be encapsulated in a single microchip, an integrated circuit (IC) usually called a charge controller IC or charge control IC. The charge controller battery management system ensures that each device receives the appropriate rate of charge and voltage. The charge controller allows the device to off load charge to the micro grid, mini grid and V2X charger.

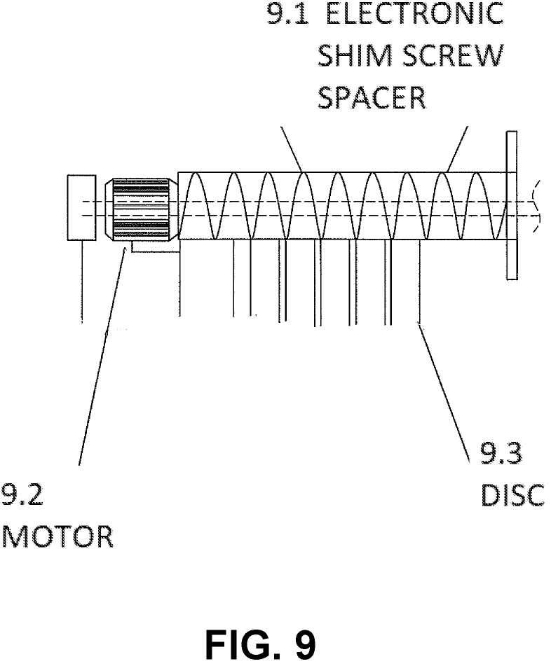

FIG. 9 depicts a smart shim electronic spacer. This device optimizes gaping and averts catastrophic failure. This device allows the charge computer to control the gaping to reduce or increase the amount of charge produced.

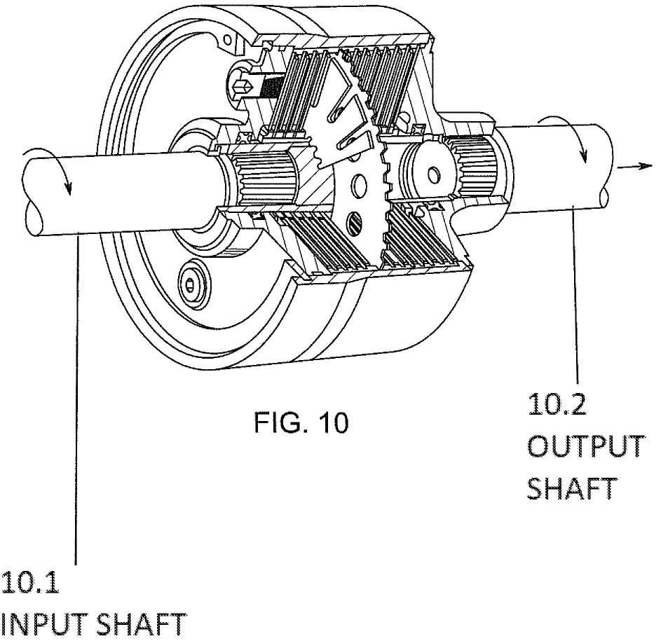

FIG. 10 depicts a viscous coupler. This device allows the rotors to spin freely whenever the axel speed is less than the speed of the rotors.

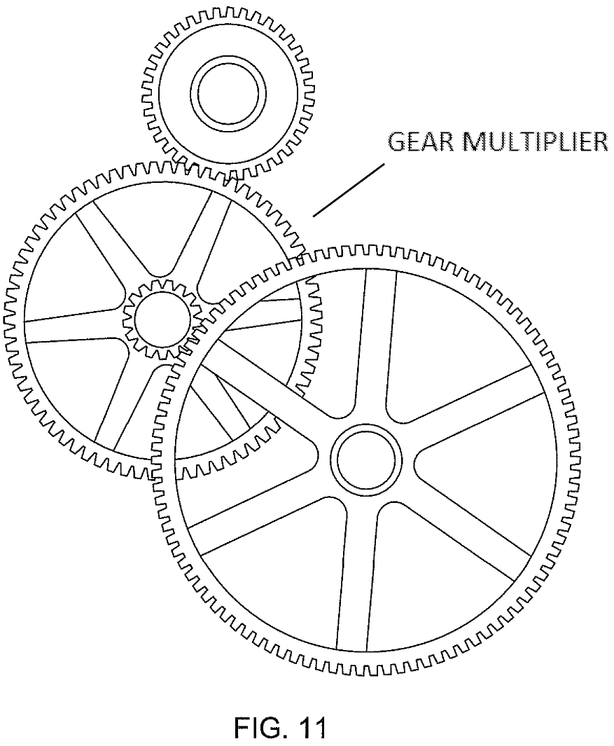

FIG. 11 depicts a gear multiplier according to an embodiment. This device allows the axel or shaft speed to be greatly increased to maximize charge.

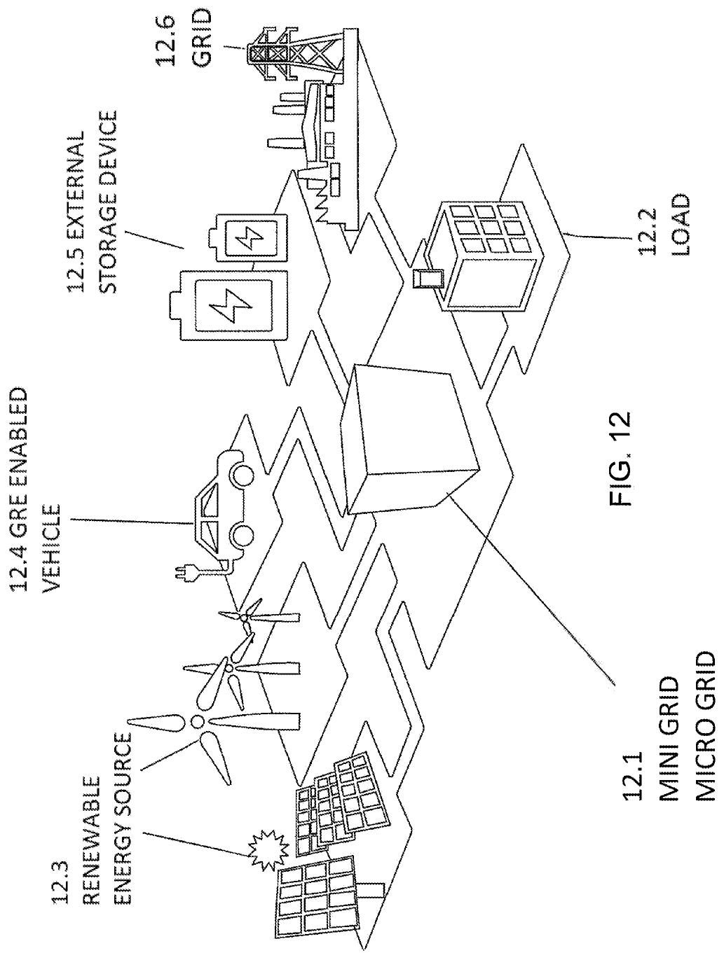

FIG. 12 depicts an electronic fleet management system according to an embodiment. This device allows the subject vehicle to communicate with a remote system that monitors multiple vehicles and loads. This device will alert the system to charge surplus or deficiencies so that the proper strategy can be used to either discharge excess charge either at a microgrid, minigrid or other vehicles in need of charge.

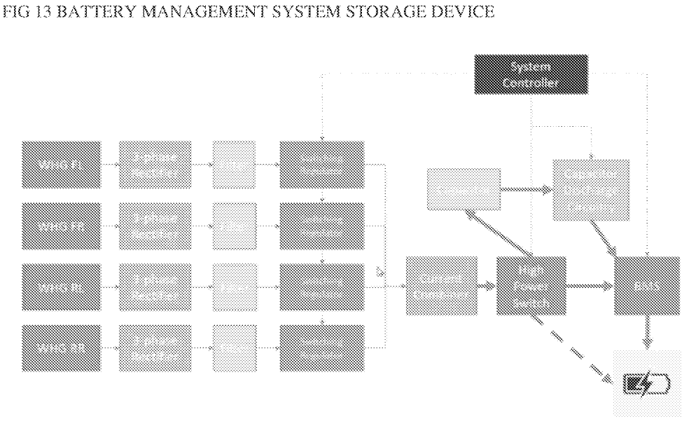

FIG. 13 depicts a smart storage system (ultracapacitor, battery, battery management system, inverter/rectifier). This device works with the charge controller to manage all charge input and output. The device ensures that the proper voltage and current arrives at the correct destination. This device also helps facilitate the discharge of excess current stored in the ultracapacitor for use in the microgrid.

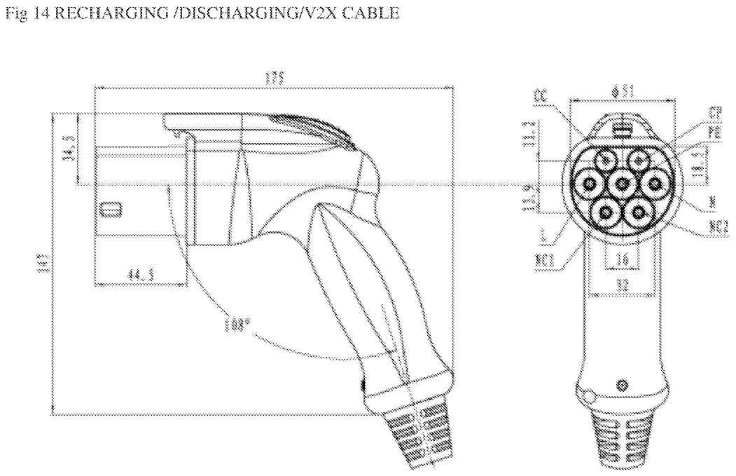

FIG. 14 depicts a recharging/discharging/V2X cable. This device allows the vehicle to be recharged or discharged to the micro grid, other vehicles or an alternate storage device.

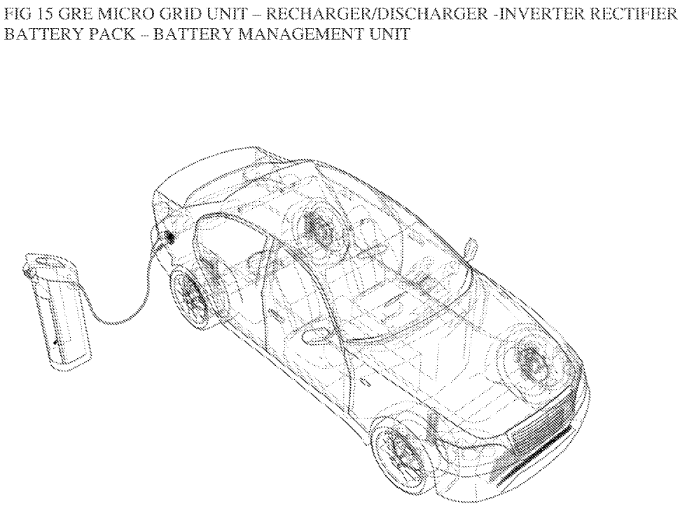

FIG. 15 depicts a microgrid unit- recharger/discharger, inverter rectifier battery pack and battery management unit according to an embodiment. This device allows the vehicle to be recharged or allows for discharge of excess charge. The excess power can be used to power other vehicles, buildings or fed back to the electric grid.

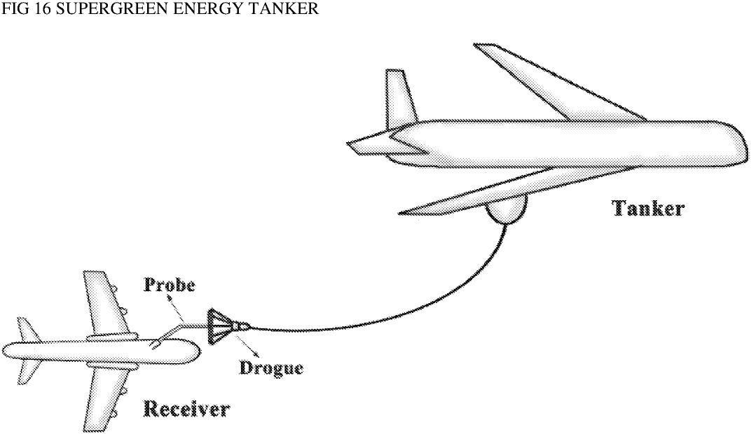

FIG. 16 depicts a “supergreen” energy tanker according to an embodiment. This device can contain multiple GREs that are placed in series and their combined stored energy can be used to recharge vehicles on land air and sea.

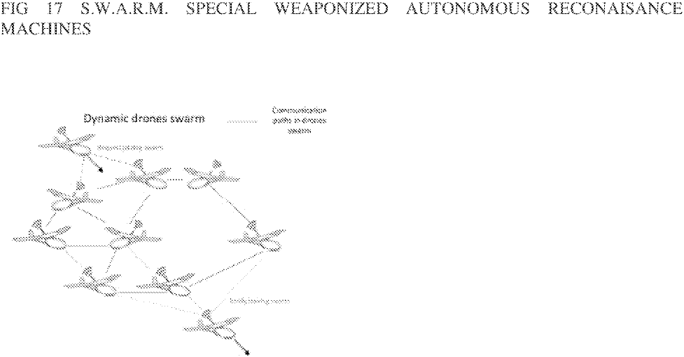

FIG. 17 depicts an embodiment of a Special Weaponized Autonomous Reconnaissance Machines (S.W.A.R.M.). This device when combines with the GRE SuperGreen Tanker allows for maximum saturation of drones with the ability to operate over long periods and carryout a myriad of functions and task.

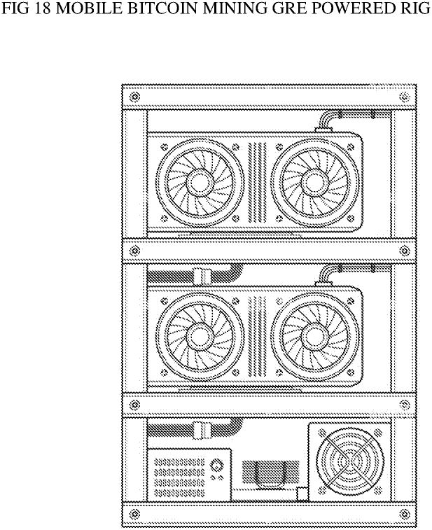

FIG. 18 depicts an embodiment of a mobile bitcoin mining rig powered by the range extending apparatus in one embodiment. This device can be added to any vehicle to process bitcoins using the GRE as a power supply.

In embodiments, there is provided a high-speed, high efficiency, heat resistant, fluid turbine generator type range extender, motor and recharger for electric vehicles, equipment, devices and machinery (herein “vehicle”) characterized as including: a computer controlled Concentrating Ducting Inlet (CDI) which controls the flow of the subject fluid, high speed heat and warp resistant turbine comprised of circular heat and warp resistant discs, outer casing to hold the disc, an axle that is connected to the disc, said axel passes through the generator and thus passes through the armature, armature winding, permanent magnets, charge controller which directs the flow of electricity either to the vehicle, ultracapacitor, other storage devices, flywheel or the battery bank, computer control systems, sensors, smart electronic shim, ultracapacitor storage device, charge strip, viscous coupler, gearing, rectifier/inverter, discharger/recharger and micro grid. The device creates so much power that it can be used to power a myriad of auxiliary devices and vehicle accessories that where not possible prior to it design like the super green recharger tanker platform, a mobile bitcoin mining rigs and a swarm of drones.

In the high-speed high efficiency heat resistant fluid turbine generator type range extender and recharger for electric vehicles, the device components of the present invention, as generally described could be arranged and designed in a wide variety of different configuration. The primary design is such that an electric vehicle range extending charging system including: a computer-controlled CDI which is attached to the vehicle in such a way as to maximize the flow of fluids across the surface of the vehicle and direct that flow into the casing inlet; a fluid cooled casing which holds several thin heat resistant warp resistant discs which have exhaust holes. These discs are spaced so that they minimize drag and wherein the spacing is controlled by an electronic smart shim spacer. These discs are arranged in the casing as to create a vortex within the casing that increases the rotational energy of the axel; a fluid cooled pancake generator that is powered by a rotor that is connected to a rotating axel that creates a magnetic field in the stator and is connected to the several disc which are housed in a casing where the discs are forced to spin by the boundary layer effect of fluid on the surface of the disc, said fluid which is forced through the casing inlet; and a charge controller battery management system which directs the flow of electricity either to the vehicle or the storage devices.

Further in the high-speed high efficiency heat resistant warp resistant fluid turbine generator type range extender and recharger for electric vehicles, the fluid pressure creates a rotational energy in the disc which spins the axel which powers the generator such that as the permanent magnets pass through the coil field of the copper wire where electricity is produced.

Further, in the high-speed high efficiency heat resistant fluid turbine generator type range extender and recharger for electric vehicles, the computer controlled Concentrating Ducting Inlet (CDI) controls the flow of the subject fluid, high speed heat and warp resistant turbine comprised of circular heat and warp resistant discs, outer casing to hold the disc, an axle that is connected to the disc, armature winding, permanent magnets, charge controller, computer control system, sensors and battery bank. This is a high-speed turbine which is connected to a high efficiency generator and a battery bank in which the power output is controlled by a charge controller, where the generator design is driven by the high-speed turbine, together they will deliver power to the engine directly or can be diverted to the battery bank for the purposes of recharging. This device can be configured several ways.

In an embodiment, a primary way to configure this device is denoted in this disclosure as Device 1. In the case of Device 1 the CDI is mounted to the outside surface of the electric vehicle in such a way as to promote fluid flow. The fluid then enters the CDI and is fed into the turbine device which spins the disc, which in turn spin the axle mounted at the center of the turbine, this spinning axle rotates a magnet through a copper field. This copper field produces electricity which is diverted to the charge controller which either powers the vehicle or recharges the battery bank. This entire device is controlled by a computer control system that monitors the entire operation for efficiency, performance, and optimization.

This entire assembly constitutes a “Grayson Range Extender 3.0”. This high-speed high efficiency heat resistant warp resistant turbine, high-capacity generator, computer control system and charge controller are all completely concealed by the body of the vehicle. The magnetic field is created through electric current in the wire-wound coil. The armature coil assembly converts the mechanical energy of the rotating axel into electrical energy by passing the permanent magnet through the armature winding. The Rotor produces rotating magnetic flux or rotating magnetic field associated with the rotor inducing electricity in the armature coil attached to the high-speed turbine. The electricity produced is then diverted to the charge controller. The charge controller now powers the engine directly or recharges the battery based on the current needs of the vehicle.

The device takes advantage of the viscous effect of fluids on a solid surface. When fluid enters the CDI, the fluid enters the outer casing tangential to the casing. The outer casing holds the discs. Upon the fluid entering the inlet to the outer casing the interaction between the fluid and the disc will cause the disc to spin. The spinning discs are connected to a shaft which spin the rotor in the generator and create electricity. Provision for the fluid to leave the casing is at the center of the turbine. Inlet fluid with higher pressure than the atmosphere is entering the inlet nozzle and exit the hole at atmospheric pressure. The greater the disc speed the more the fluid particles move away from the center as a result of centrifugal forces forming a spiral pattern of travel which increase the contact area of the fluid thereby increasing the viscous force on the disc, which in turn increases the RPM of the shaft, which produces more electricity. The faster the turbine rotates the more energy it extracts from the fluid which creates greater RPMs at the shaft.

In a non-limiting embodiment, the outer casing contains multiple circular disc that are approximately 0.4 mm apart in Device 1, but the distance will vary based on configuration and design. These thin discs are constructed of anti-warp heat resistant materials. The disc takes advantage of the boundary layer effect. The device is constructed so that the turbine and fluid work in the same plane. The Casing device takes advantage of the low-pressure exhaust which draws the fluid to the discharge port and smoothly guides the fluid to the exhaust port. The discharge ports are placed at the lateral part of the casing toward the center. At the center of the device is an axel. This device becomes a rotor. This rotor is a simple axis with several thin disc arranged at an optimal distance to reduce drag forces. Placed inside the casing right at the center of the vortex. The discs are designed to draw the fluid to the exhaust port. The Disc have incorporated spacers which create paths to guide the air to the center exhaust hub. The discs are arranged in a stepping staircase design which helps to create a vortex in the device. This device uses front and rear cover with exhaust ports, and turbine disc with holes in the center for exhaust.

The computer-controlled CDI is further designed so that it gradually constricts the passage of fluid which increase the speed and pressure of the fluid. This process is optimized by the computer to maximize the viscous force on the disc. The CDI will use a Convergent divergent style nozzle to accelerate the fluid. The CDI also incorporates a computer-controlled flow regulator.

The high-speed high efficiency heat resistant warp resistant fluid turbine generator type range extender and recharger for electric vehicles system can be mounted in an aircraft, commercial vehicle or other form of transportation such that it can be characterized as a GRE “SuperGreen” energy refueling tanker. This ship, road vehicle, or aircraft for carrying, producing and storing electricity, in bulk for the purpose of refueling.

The high-speed high efficiency heat resistant warp resistant fluid turbine generator type range extender and recharger for electric vehicles system, when configured as a SuperGreen tanker, can be used to support and refuel a fleet of drones that can be used offensively or defensively for reconnaissance and aggression. These become special weaponized autonomous reconnaissance machines (S.M.A.R.T.), and are powered by the GRE and the group of drones are serviced by a GRE SuperGreen energy tanker.

The high-speed high efficiency heat resistant warp resistant fluid turbine generator type range extender and recharger for electric vehicles, further can power a Mobile bitcoin mining (MBM) rig that will mine new bitcoins. “Mining” is performed using sophisticated MBM hardware that solves an extremely complex computational math problem. The first computer to find the solution to the problem receives the next block of bitcoins and the process begins again. Normally cryptocurrency mining is painstaking, costly, and only sporadically rewarding. MBM mining has made this process simple because of the fact that miners receive rewards for their work with crypto tokens simply by driving their car. The bitcoin reward that miners receive will take approximately five years to produce a single coin. Which means that the driver miner can use the coin to pay for their auto or to assist in the payments.

The high-speed, high efficiency, heat resistant, fluid turbine generator type range extender, motor and recharger for electric vehicles, appliances, equipment, devices and machinery (herein “vehicle”) is characterized by comprising a computer controlled, adjustable Concentrating Ducting Inlet (CDI) which controls the flow of the subject fluid, high speed heat and warp resistant turbine comprised of circular heat and warp resistant discs, outer fluid cooled casing to hold the disc, an axle that is connected to the disc, armature windings, permanent magnets, pancake shaped stator and rotor, charge controller, computer control system, sensors, Smart Electronic Shim (SES), Smart Storage Device (SSD) which is a combination of an ultracapacitor and battery storage device with a battery management system, charge strip, viscous coupler, gearing, other componentry, other storage devices and battery bank. This is a high-speed turbine which is connected to a high efficiency generator and a battery bank in which the power output is controlled by a charge controller or power management system, where the generator design is driven by the high-speed turbine, together they will deliver power to the engine directly or can be diverted to the battery bank, ultracapacitor, flywheel or other storage device.

This device can be configured several ways. The primary ways to configure this device are denoted in this application as Device 1. In the case of Device 1 the CDI is mounted to the outside surface of the electric vehicle in such a way as to promote and capture fluid flow. The fluid then enters the CDI and is fed into the turbine device which spins the disc, which in turn spin the axle mounted at the center of the turbine, this spinning axle rotates a magnet through a copper field. This copper field produces electricity which is diverted to the charge controller which either powers the vehicle, is stored, or recharges the battery bank. This entire device is controlled by a computer-controlled power management system that monitors the entire operation for efficiency, performance, and optimization.

This entire assembly constitutes the Grayson Range Extender 3.0. This device is a new technology that was developed from a new science called Advanced Kinetic Energy Recovery Systems (AKERS). Advanced kinetic energy recovery system (AKERS) is the science of creating a system or device for recovering all the energy associated with the natural movement or motion of the subject vehicle, equipment or mechanism and converting it into electrical energy such that it can be used to power the vehicle, equipment, or mechanism, store all excess power in a battery, ultracapacitor, or as mechanical energy in a flywheel.

AKERS uses the law of conservation of energy which states that energy can neither be created nor destroyed - only converted from one form of energy to another. Therefore, AKERS is the science of conservation of work done by or on a system. Where the value of green work (W^{G}) is maximized and calculated by the Grayson Principle. The Grayson Principle allows for the calculation of self-charging SuperGreen capacity, where W^{G}= (E+RE) - L. Such that E=the initial total energy added to the system, RE= the recovered energy from the system which can be added back to the system, and L= the energy loss associated with E and RE which can be in the form of heat, load, transmission, light or sound energy.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

What is claimed is:

1. A high-speed, high efficiency, heat resistant, fluid turbine generator type range extender, motor and recharger apparatus for electric vehicles, equipment, devices and machinery(herein “vehicle”) is characterized by comprising a computer controlled Concentrating Ducting Inlet (CDI) which controls the flow of the subject fluid, high speed heat and warp resistant turbine comprised of circular heat and warp resistant discs, outer casing to hold the disc, an axle that is connected to the disc, said axel passes through the generator and thus passes through the armature, armature winding, permanent magnets, charge controller which directs the flow of electricity either to the vehicle, ullracapacitor, other storage devices, flywheel or the battery bank, computer control systems, sensors, smart electronic shim, ullracapacitor storage device, charge strip, viscous coupler, gearing, rectifier/inverter, discharger/recharger and micro grid.

2. The range extender, motor and recharger apparatus as claimed in claim 1, configured to create power that it can be used to power a myriad of auxiliary devices and vehicle accessories that were heretofore not possible prior to it design like the super green recharger tanker platform, a mobile bitcoin mining rigs and a swarm of drones.

3. The range extender, motor and recharger apparatus according to claim 1, wherein said device components are arranged and designed in a wide variety of different configuration, one design as an electric vehicle range extending charging system comprising:
a computer-controlled CDI which is attached to the vehicle in such a way as to maximize the flow of fluids across the surface of the vehicle and direct that flow into the casing inlet;
a fluid cooled casing which holds several thin heat resistant warp resistant discs which have exhaust holes, the discs are spaced so that they minimize drag and wherein the spacing is controlled by an electronic smart shim spacer; and the discs are arranged in the casing as to create a vortex within the casing that increases the rotational energy of the axle;
a fluid cooled pancake generator that is powered by a rotor that is connected to a rotating axel that creates a magnetic field in the stator and is connected to the several disc which are housed in a casing where the discs are forced to spin by the boundary layer effect of fluid on the surface of the disc, said fluid which is forced through the casing inlet; and
a charge controller battery management system which directs the flow of electricity either to the vehicle or the storage devices.

4. The range extender, motor and recharger apparatus according to claim 1, wherein a fluid pressure creates a rotational energy in the disc which spins the axel which powers the generator such that as the permanent magnets pass through the coil field of the copper wire where electricity is produced.

5. The range extender, motor and recharger apparatus according to claim 1, wherein the computer controlled Concentrating Ducting Inlet (CDI) controls the flow of the subject fluid; and
a high speed heat and warp resistant turbine comprised of circular heat and warp resistant discs, outer casing to hold the disc, an axle that is connected to the disc, armature winding, permanent magnets, charge controller, computer control system, sensors and a battery bank;
the high-speed heat and warp resistant turbine being connected to a high efficiency generator and the battery bank in which the power output is controlled by a charge controller, where the generator design is driven by the high-speed turbine, together deliver power to the engine directly or can be diverted to the battery bank for the purposes of recharging.

6. The range extender, motor and recharger apparatus according to claim 1, wherein the CDI is mounted to the outside surface of the electric vehicle in such a way as to promote fluid flow, said fluid entering the CDI and is fed into the turbine device which spins the disc, which in turn spin the axle mounted at the center of the turbine, this spinning axle rotates a magnet through a copper field, the copper field produces electricity which is diverted to the charge controller which either powers the vehicle or recharges the battery bank.

7. The range extender, motor and recharger apparatus according to claim 1, further comprising a computer control system that monitors the entire operation for efficiency, performance, and optimization.

8. The range extender, motor and recharger apparatus according to claim 1, wherein the high-speed high efficiency heat resistant warp resistant turbine, high-capacity generator, computer control system and charge controller are all completely concealed by the body of the vehicle.

9. The range extender, motor and recharger apparatus according to claim 1, wherein a magnetic field is created through electric current in the wire-wound coil, the armature coil assembly converting the mechanical energy of the rotating axel into electrical energy by passing the permanent magnet through the armature winding; and a rotor producing rotating magnetic flux or rotating magnetic field associated with the rotor inducing electricity in the armature coil attached to the high-speed turbine, wherein the electricity produced is then diverted to the charge controller for powering the engine directly or recharging the battery based on the current needs of the vehicle.

10. The range extender, motor and recharger apparatus according to claim 1, further comprising: employing a viscous effect of fluids on a solid surface, wherein when fluid enters the CDI, the fluid enters the outer casing tangential to the casing, the outer casing holding the discs, wherein upon the fluid entering the inlet to the outer casing the interaction between the fluid and the disc will cause the disc to spin, the spinning discs are connected to a shaft which spin the rotor in the generator and create electricity.

11. The range extender, motor and recharger apparatus according to claim 10, further comprising a provision for the fluid to leave the casing at the center of the turbine, wherein inlet fluid with higher pressure than the atmosphere is entering an inlet nozzle and exit the hole at atmospheric pressure, wherein the greater the disc speed the more the fluid particles move away from the center as a result of centrifugal forces forming a spiral pattern of travel which increase the contact area of the fluid thereby increasing the viscous force on the disc, which in turn increases the RPM of the shaft, which produces more electricity, and wherein the faster the turbine rotates the more energy it extracts from the fluid which creates greater RPMs at the shaft.

12. The range extender, motor and recharger apparatus according to claim 10, wherein the outer casing contains multiple circular discs that are approximately 0.4 mm apart.

13. The range extender, motor and recharger apparatus according to claim 12, wherein the thin circular discs are constructed of anti-warp heat resistant materials, each disc taking advantage of the boundary layer effect, wherein the device is constructed so that the turbine and fluid work in the same plane.

14. The range extender, motor and recharger apparatus according to claim 12, wherein the casing takes advantage of the low-pressure exhaust which draws the fluid to the discharge port and smoothly guides the fluid to the exhaust port, the discharge ports being placed at the lateral part of the casing toward the center.

15. The range extender, motor and recharger apparatus according to claim 12, wherein at the center of the device is an axel such that the device becomes a rotor, the rotor having a simple axis with several thin disc arranged at an optimal distance to reduce drag forces.

16. The range extender, motor and recharger apparatus according to claim 12, wherein placed inside the casing right at the center of a vortex, the discs are designed to draw the fluid to the exhaust port, and a disc having incorporated spacers which create paths to guide the air to the center exhaust hub, and wherein the discs are arranged in a stepping staircase configuration to create the vortex in the device, the device using front and rear cover with exhaust ports, and turbine disc with holes in the center for exhaust.

17. The range extender, motor and recharger apparatus according to claim 1, wherein the computer-controlled CDI is designed so that it gradually constricts the passage of fluid which increase the speed and pressure of the fluid, wherein the computer maximizes the viscous force on the disc; and wherein the CDI uses a convergent/divergent style nozzle to accelerate the fluid and incorporates a computer-controlled flow regulator.

18. The range extender, motor and recharger apparatus according to claim 1, adapted for mounting in an aircraft, ship, commercial vehicle or other form of transportation and configured as a SuperGreen energy refueling tanker, wherein the ship, road vehicle, or aircraft adapted for carrying, producing and storing electricity, in bulk for the purpose of refueling.

19. The range extender, motor and recharger apparatus according to claim 18, wherein the SuperGreen tanker supports and refuels a fleet of drones that can be used offensively or defensively for reconnaissance and aggression, wherein the device is configured as a Special Weaponized Autonomous Reconnaissance Machine, powered by the GRE and a group of drones are serviced by the SuperGreen energy tanker.

20. The range extender, motor and recharger apparatus according to claim 18, further comprising a mobile bitcoin mining (MBM) rig for mining new bitcoins using power from said vehicle, said mining performed using MBM hardware that solves an extremely complex computational math problem, wherein a first computer finds a solution to the problem, receives a next block of bitcoins.
